(19) United States
(12) Patent Application Publication
(10) Pub. No.: US 2008/0010153 A1
(43) Pub. Date: Jan. 10, 2008

(54) COMPUTER NETWORK PROVIDED DIGITAL CONTENT UNDER AN ADVERTISING AND REVENUE SHARING BASIS, SUCH AS MUSIC PROVIDED VIA THE INTERNET WITH TIME-SHIFTED ADVERTISEMENTS PRESENTED BY A CLIENT RESIDENT APPLICATION

(76) Inventors: Archie Pugh-O'Connor, New York, NY (US); York Baur, Issaquah, WA (US); Keith Smith, Bellevue, WA (US); Daniel Todd, Bothell, WA (US); Jeff Malek, Seattle, WA (US); Stanton D. Monlux, Seattle, WA (US)

Correspondence Address: PERKINS COIE LLP;PATENT-SEA, P.O. BOX 1247, SEATTLE, WA, 98111-1247, US

(21) Appl. No.: 11/739,663

(22) Filed: Apr. 24, 2007

Related U.S. Application Data
(60) Provisional application No. 60/794,626, filed on Apr. 24, 2006.

(51) Int. Cl. G06Q 30/00; G06Q 40/00

(52) U.S. Cl. 705/14; 705/39

(57) ABSTRACT

A system for providing digital content to users under an advertising and revenue sharing basis. The system may provide music to users via the Internet, in combination with time-shifted advertisements presented by an application that resides on the user's computer. The system receives digital advertisements from advertisers and digital content from content providers. Advertisers provide compensation based on the presentation of their advertisements to users. Content providers receive a variable amount of compensation based on how many users access the digital content during a particular time period. Each content provider may receive a share of the advertising revenue that is generated by each user that accesses content during a particular time period.

### CROSS-REFERENCE TO RELATED APPLICATION(S)

This application claims the benefit of U.S. Provisional Patent Application No. 60/794,626, filed Apr. 24, 2006 (attorney docket number 34353-8002.US00).

### BACKGROUND

An increasing amount of digital content is available via computer networks, such as the Internet. Digital content may include audio content, video content, audiovisual content, applications, and other content. Digital content may be available to users via a network for a fee, or it may be available free of charge. An increasing number of users are acquiring digital content illegally, not paying the fee due to the content provider for such acquisition.

Digital content may be available via a computer network for a fee, such as through a subscription service, pay-per-acquisition (e.g., pay-per-download) service, or another service. In a typical subscription service, a content provider, such as a record label, may receive a fixed amount of compensation for providing its content (e.g., music files) to the service. The service makes the content available to users and charges the users a fee that is paid for each subscription period (e.g., month, year, or other period). The user may typically access as many content files as the user wishes during the subscription period. In a typical pay-per-acquisition service, a content provider may receive a fixed amount of compensation each time one of the content files it provided to the service is accessed by a user. For example, a record label may receive $0.70 each time one of its songs is accessed (e.g., downloaded) by a user. A user typically pays a fixed fee (e.g., $1.00) for each acquisition.

Digital content may also be available via a network for free. Content providers may not receive any compensation for the content they provide to users free of charge. This may discourage content providers from providing content to users. If content providers do receive compensation for content that is provided to non-paying users, it is typically a fixed amount. For example, a network site that offers a song for free will typically pay the record label a fixed amount (e.g., $0.01) each time the song is played.

Digital content may also be available via a network for free when it is distributed in combination with digital advertisements. A network site that offers digital content and digital advertisements will typically display the advertisements at the same time as the content is displayed, or immediately preceding or following display of the content. Advertisements may be displayed in a banner on a network site page, as a pop-up/pop-under window, or in another manner. These advertisements can be distracting to users and can discourage users from taking advantage of free content.

At the same time, many computer network users do not want to pay subscription, per-acquisition, or other fees for digital content. Users may attempt to acquire content for which a fee is due to a content provider without paying the fee due. For example, a first network user may acquire a song directly from a second network user, such as by copying the song for free. While the second network user may have legally acquired the song (e.g., by purchasing the song), the first user has illegally acquired the song by not paying the fee due to the content provider.

### BRIEF DESCRIPTION OF THE DRAWINGS

FIG. 1 is a block diagram of a basic and suitable computer that may employ aspects of the invention.

FIG. 2A is a block diagram illustrating a simple, yet suitable system in which aspects of the invention may operate in a networked computer environment.

FIG. 2B is a block diagram illustrating an alternative system to that of FIG. 2A.

FIG. 3 is a block diagram illustrating a suitable system in which aspects of the invention may operate in a network environment.

FIG. 4 is a flow diagram illustrating a method of providing digital content to users under an advertising and revenue sharing basis.

FIG. 5 is a flow diagram illustrating a method of providing a user with access to content.

FIG. 6 is a flow diagram illustrating an alternative method of providing a user with access to content.

FIG. 7 is a flow diagram illustrating a method by which a user may email a song or playlist to another user.

FIG. 8 is a flow diagram illustrating a method by which a user may receive and listen to a song or playlist sent by another user.

FIG. 9 is a flow diagram illustrating a method of adding content and metadata provided by one or more content providers to a media database maintained by the system.

Note: The headings provided herein are for convenience and do not necessarily affect the scope or interpretation of the invention.

### DETAILED DESCRIPTION

Various examples of the invention will now be described. The following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description of the various examples.

The terminology used in the description presented below is intended to be interpreted in its broadest reasonable manner, even though it is being used in conjunction with a detailed description of certain specific embodiments of the invention. Certain terms may be emphasized below; however, any terminology intended to be interpreted in any restricted manner will be overtly and specifically defined as such in this Detailed Description section.

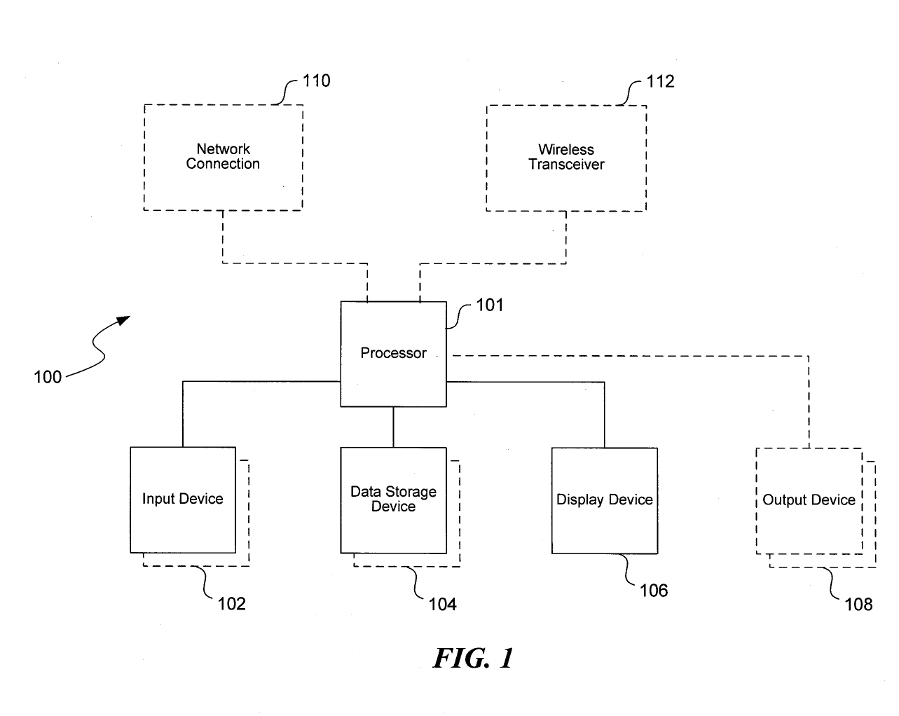

FIG. 1 and the following discussion provide a brief, general description of a suitable computing environment in which aspects of the invention can be implemented. Although not required, aspects and embodiments of the invention may be described in the general context of computer-executable instructions, such as routines executed by a general-purpose computer, e.g., a server or personal computer. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The invention can be embodied in a special purpose computer or data processor that is specifically programmed, configured, or constructed to perform one or more of the computer-executable instructions explained in detail below. Indeed, the term “computer,” as used generally herein, refers to any of the above devices, as well as any data processor.

Referring to FIG. 1, one embodiment of the invention employs a computer 100, such as a personal computer or workstation, having one or more processors 101 coupled to one or more user input devices 102 and data storage devices 104. The computer is also coupled to at least one output device such as a display device 106 and one or more optional additional output devices 108 (e.g., printer, plotter, speakers, tactile, or olfactory output devices, etc.). The computer may be coupled to external computers, such as via an optional network connection 110, a wireless transceiver 112, or both.

The input devices 102 may include a keyboard and/or a pointing device such as a mouse. Other input devices are possible such as a microphone, joystick, pen, game pad, scanner, digital camera, video camera, and the like. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN), or the Internet (not shown in FIG. 1).

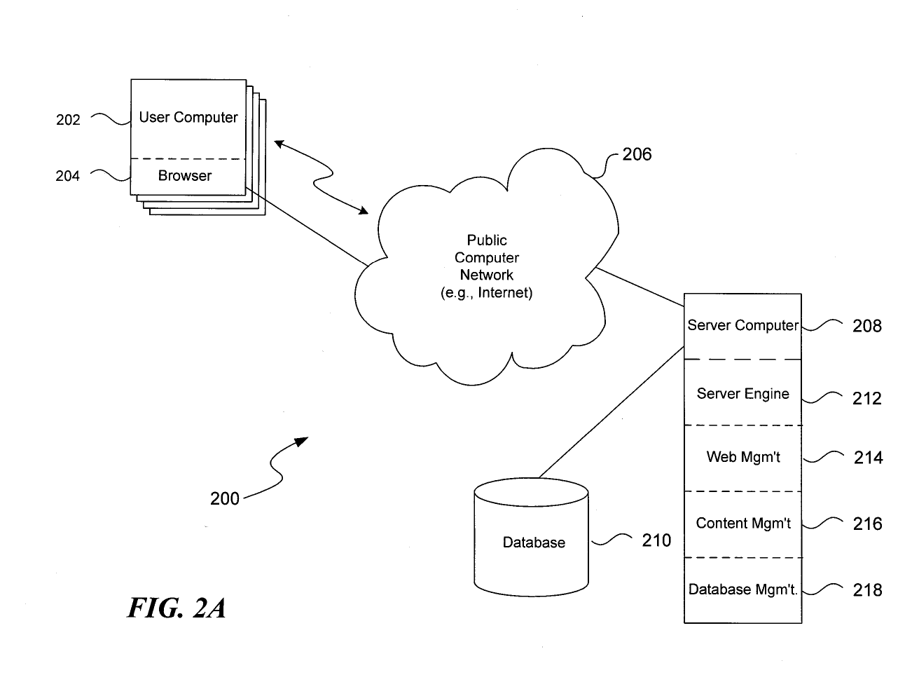

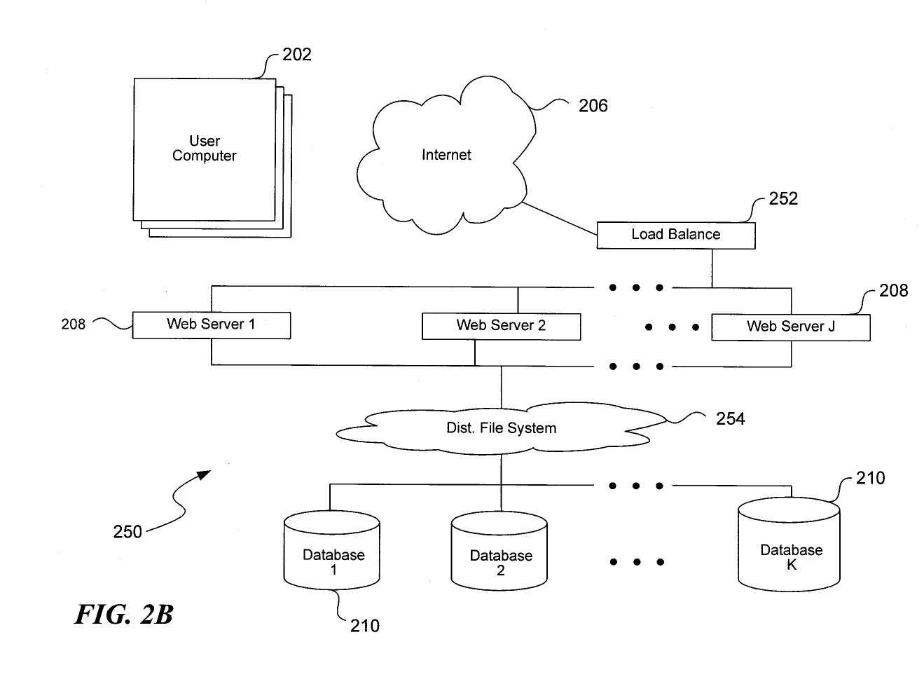

Aspects of the invention may be practiced in a variety of other computing environments. For example, referring to FIG. 2A, a distributed computing environment with a web interface includes one or more user computers 202 in a system 200 are shown, each of which includes a browser program module 204 that permits the computer to access and exchange data with the Internet 206, including web sites within the World Wide Web portion of the Internet. The user computers may be substantially similar to the computer described above with respect to FIG. 1. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. More importantly, while shown with web browsers, any application program for providing a graphical user interface to users may be employed, as described in detail below; the use of a web browser and web interface are only used as a familiar example here.

At least one server computer 208, coupled to the Internet or World Wide Web (“Web”) 206, performs many or all of the functions for receiving, routing, and storing of electronic messages, such as web pages, audio signals, and electronic images. While the Internet is shown, a private network, such as an intranet, may indeed be preferred in some applications. The network may have a client-server architecture, in which a computer is dedicated to serving other client computers, or it may have other architectures such as a peer-to-peer, in which one or more computers serve simultaneously as servers and clients. A database 210 or databases, coupled to the server computer(s), stores many of the web pages and content exchanged between the user computers, including digital content and advertisements. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 208 may include a server engine 212, a web page management component 214, a content management component 216, and a database management component 218. The server engine performs basic processing and operating system level tasks. The web page management component handles creation and display or routing of web pages or screens associated with receiving and providing digital content and advertisements. Users may access the server computer by means of a URL associated therewith. The content management component handles most of the functions in the embodiments described herein. The database management component includes storage and retrieval tasks with respect to the database, queries to the database, and storage of data such as video, graphics, and audio signals.

Referring to FIG. 2B, an alternative embodiment to the system 200 is shown as a system 250. The system 250 is substantially similar to the system 200, but includes more than one server computer (shown as server computers 1, 2, . . . J). A load balancing system 252 balances load on the several server computers. Load balancing is a technique well-known in the art for distributing the processing load between two or more computers, to thereby more efficiently process instructions and route data. Such a load balancer can distribute message traffic, particularly during peak traffic times.

A distributed file system 254 couples the web servers to several databases (shown as databases 1, 2 . . . K). A distributed file system is a type of file system in which the file system itself manages and transparently locates pieces of information (e.g., content pages) from remote files or databases and distributed files across the network, such as a LAN. The distributed file system also manages read and write functions to the databases.

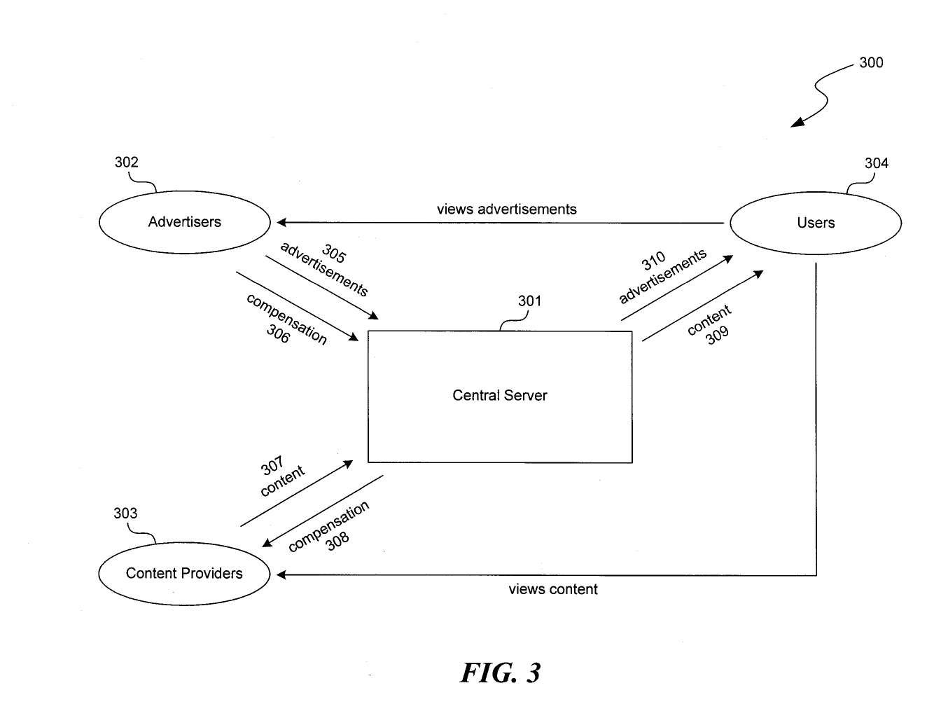

A system for providing digital content to users under an advertising and revenue sharing basis is described. In some examples, the system may provide music to users via the Internet, in combination with time-shifted advertisements presented by an application that resides on the user's computer system. FIG. 3 illustrates one example of the system. A central server 301 receives digital advertisement data 305 from advertisers 302. Advertisers 302 provide compensation 306 based on the presentation of their advertisements 310 to users 304. The central server 301 receives digital content 307 from content providers 303. Digital content may be audio content, visual content, audiovisual content, applications, or other content. Content providers 303 receive a variable amount of compensation 308 based on how many users 304 access the digital content 309 during a particular time period (e.g., one week, one month, or another time period) or based on other usage data. The system provides user-selected digital content 309 and user-targeted digital advertisements 310 to users 304. Further details are provided below.

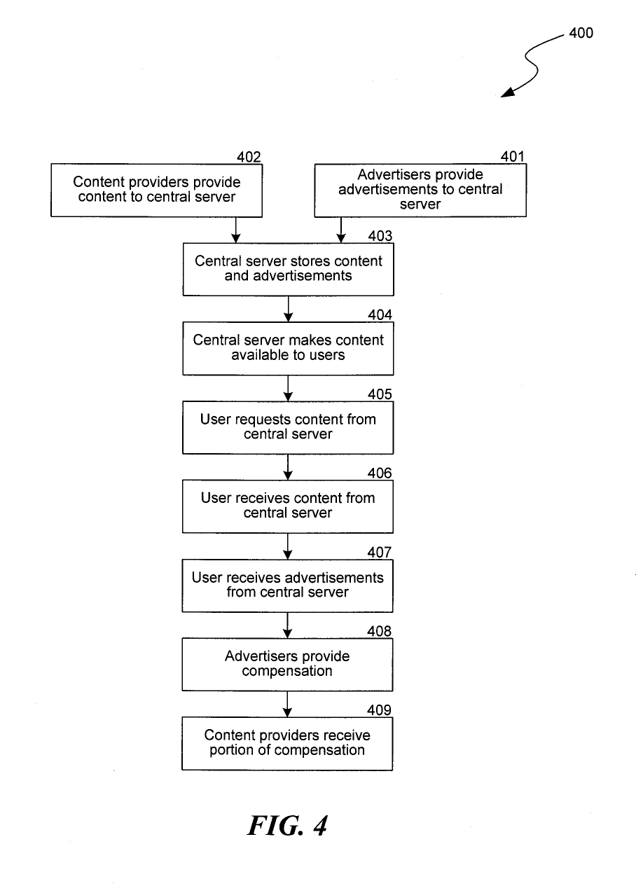

FIG. 4 illustrates a process 400 by which the system may provide digital content to users under an advertising and revenue sharing basis. At a block 401 advertisers provide digital advertisement data to the system. An advertisement may be any announcement designed to attract a user's attention, including, but not limited to, a web address to be launched in a browser window by the system. The web address may be an address for an advertiser's web site or web page. Each advertiser may specify one or more targeting criteria, including but not limited to keywords, to be associated with each of its advertisements. A keyword is a word or phrase that may trigger the system to provide the advertisement to a user. In some examples, the system may prohibit an advertiser from purchasing targeting criteria that are not relevant to the products or services offered by the advertiser. In this way, the system may provide relevant, contextual advertisements to users. In addition, each advertiser may specify a bid value associated with each of the specified targeting criteria. A bid value is an amount of compensation that an advertiser is willing to pay for the presentation of its advertisement to a user.

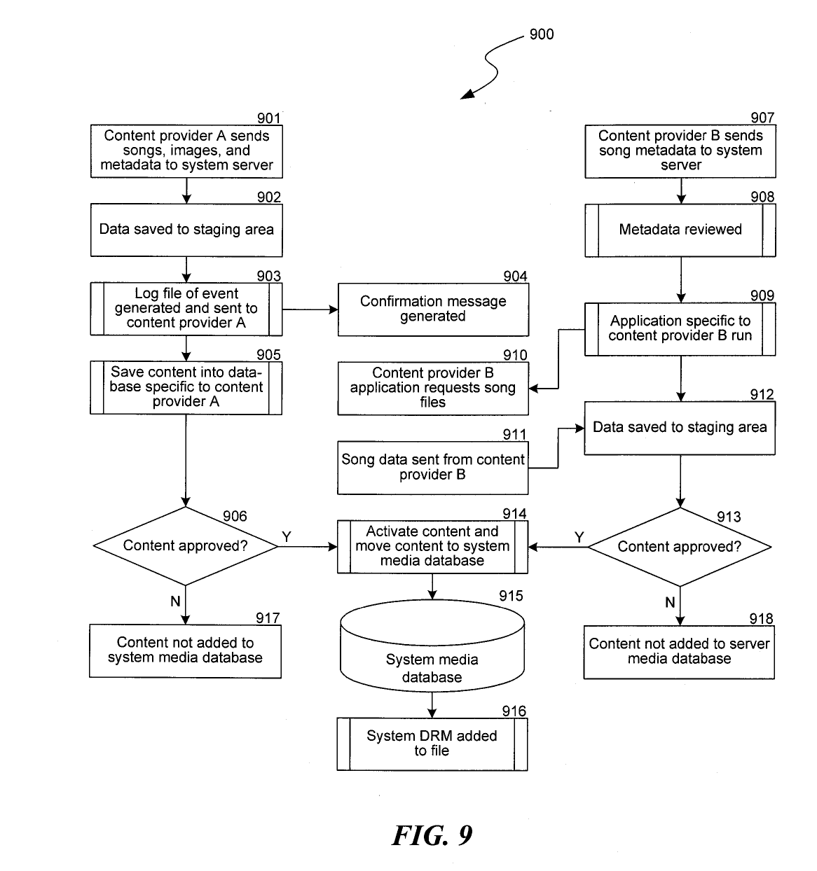

At a block 402 content providers provide digital content to the system. Digital content may include audio content, video content, audiovisual content, applications, or other content. For example, the content may be music files. FIG. 9 illustrates an example of a process 900 by which one or more content providers may provide content and metadata associated with that content to the system. Each content provider may provide content by a different process. At a block 901 content provider A may send songs, images, and metadata to a system server. At a block 902 the system may save the data received from content provider A to a staging area. A staging area may be a temporary location that holds content, metadata, and other information before the content, metadata, and other information is added to a media database 915 maintained by the system. At a block 903 a log file of the event may be generated and sent to content provider A, and at a block 904 a confirmation message may be generated. At a block 905 content may be saved by the system into a database specific to content provider A. Content may include songs, images, metadata, and other content submitted by content provider A. At a decision block 906 the system may determine whether the content provided by content provider A has been approved for inclusion in a media database 915 maintained by the system. If the content was approved, at a block 914 the content may be activated and the system may move the content to the media database 915. If the content is not approved, at a block 917 the system may not add the content to the media database.

Another content provider, such as content provider B, may provide content to the system in a different manner. At a block 907 content provider B may send song metadata to the system server. At a block 908 the system may review the metadata. At a block 909 an application specific to content provider B may be run. At a block 910 the song files may be requested by the content provider B application. At a block 911 song data may be sent to the system from content provider B, and at a block 912 the data may be saved by the system to a staging area, such as that described above. At a decision block 913 the system may determine whether the content provided by content provider B has been approved for inclusion in the media database 915. If the content has been approved, at block 914 the content may be activated and the system may move the content to the media database 915 maintained by the system, as described above. If the content is not approved, at a block 918 the system may not add the content to the media database. Once content files have been added to the media database 915, at a block 916 the system may add its own Digital Rights Management (DRM) information to content files in the media database 915. For example, system DRM rules may only permit a song to be played if a required application is installed, may limit the number of times a song may be played, may limit the type of device on which a song may be played, and other rules.

Returning to FIG. 4, at a block 403 the system receives and stores the digital content provided by content providers and the digital advertisement data provided by advertisers. At a block 404 the system makes the digital content provided by content providers available to users. Digital content may be made available via a service offered by the system via a network site, from which users may access content files. At a block 405 a user may request content from the system. The user's request may be in the form of a request to listen to a song, view a video, create a playlist, search for a song, search for another user, or another request. A user may discover a particular content file to request by searching one or more databases maintained by the system. A user may limit a search to a particular category or may search all categories. Categories may include artists, tracks, albums, users, all, and other categories. A user may enter one or more search terms into a text box or another input field. The system searches one or more of its databases according to the search terms entered by the user, and displays the matching results to the user. If the system does not find any matches, it may display a message to the user that indicates that no matches were found. A user may also discover a particular content file to request by browsing one or more catalogs offered by the system, being presented with a promotion display, or in another manner.

At a block 406 the system may provide content, or links to content, to the user. In some examples, a user is required to have an application installed on the user's computer system prior to receiving digital content and advertisements. The required application may be the Zango Search Assistant, provided by Zango, Inc. of Bellevue, Washington, or a similar client-side application. The required application may allow a user to access digital content and may deliver targeted, time-shifted digital advertisements. As described above, an advertisement may be any announcement designed to attract a user's attention, including, but not limited to, a web address to be launched in a browser window by the system. The origin of browser windows containing advertisements launched by the system may be required to be readily identifiable, such as by a title in the title bar of the browser window, the web address in the address bar of the browser window, or another identifiable manner. Time-shifted advertisements are advertisements that are presented separately from content, such as when a user is browsing the Internet or conducting an online search. For example, when a user enters a URL into a browser or conducts a search, such as by entering search terms at a network search site or into an application installed on the user's computer system, an advertisement may be presented to the user based on the search terms, keywords, or URL entered by the user, or based on another targeting criteria. Time-shifted advertisements may also be presented in one or more ways that do not require the use or installation of a client-side application.

A required application may compel user permission-based installation, such as via Zango's “Safe and Secure Search” (i.e., S3) technology. User permission may be obtained in the form of an End User License Agreement (EULA). The EULA may explain the required application in plain English, so that it is clear to the user what is being installed. These measures may prevent fraudulent installation of the required application without user consent. The required application may be easily uninstalled, such as through the “Add or Remove Programs” menu on a Windows-based computer. The required application may also re-notify each user periodically (e.g., every 90 days) to remind the user that the application is installed, what the software does, and how to remove the application if desired. The required application may also be presented in combination with a fraud reporting mechanism, such as Zango's “Closed Loop System” (CLS), which allows users to report incidents of suspected fraudulent installations. Thefraud reporting mechanism may provide the system with the information needed to find fraudulent distributors, notify all affected users, and require affected users to re-opt in to keep the application installed.

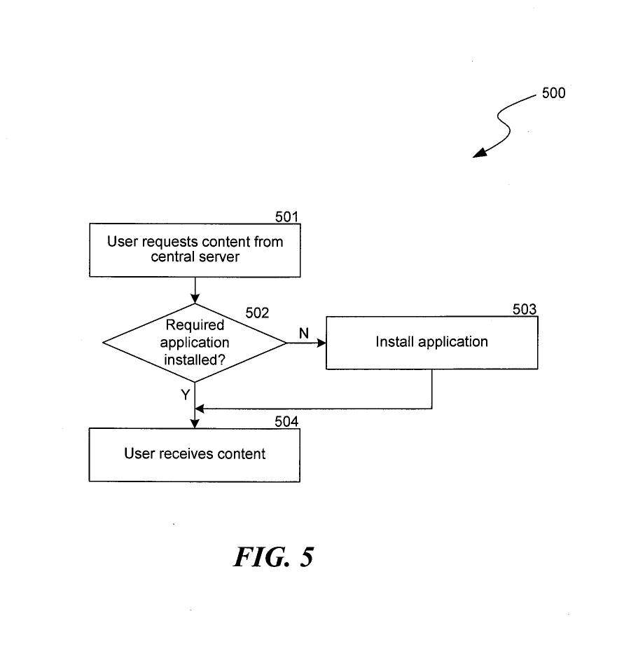

FIG. 5 illustrates a process 500 by which a user may receive content, or links to content, from the system, if a user is required to have an application installed. At a block 501 the user requests content from the system, as described above. At a decision block 502 the system evaluates whether the user has the required application installed on the user's computer system. If the user has the required application installed, at a block 504 the system provides the user with access to the content. If the user does not have the required application installed, at a block 503 the system may provide the user with an option to install the required application. The user may be required to accept a license agreement in order to install the application. If the user does not accept the license agreement or the application is not successfully installed, the system may restrict the functionality available to the user. For example, the user may be able to access only limited content or access content at a lower fidelity. Once the user has installed the required application, at a block 504 the system provides the user with access to the content. In some examples, if a user uninstalls a previously-installed application, the user will no longer be able to receive content or advertisements, unless the application is re-installed.

In some examples, the system may offer content free of charge for a limited number of plays. For example, a user may be able to listen to a song five times. At the end of the limited number of plays, the user may be presented with the option to purchase one or more content files (e.g., songs), subscribe to one or more services offered by the system, or another option. If the user chooses one of the options, the user may continue to play to the content file. If the user does not one of the options, the user's access to the content file may be restricted.

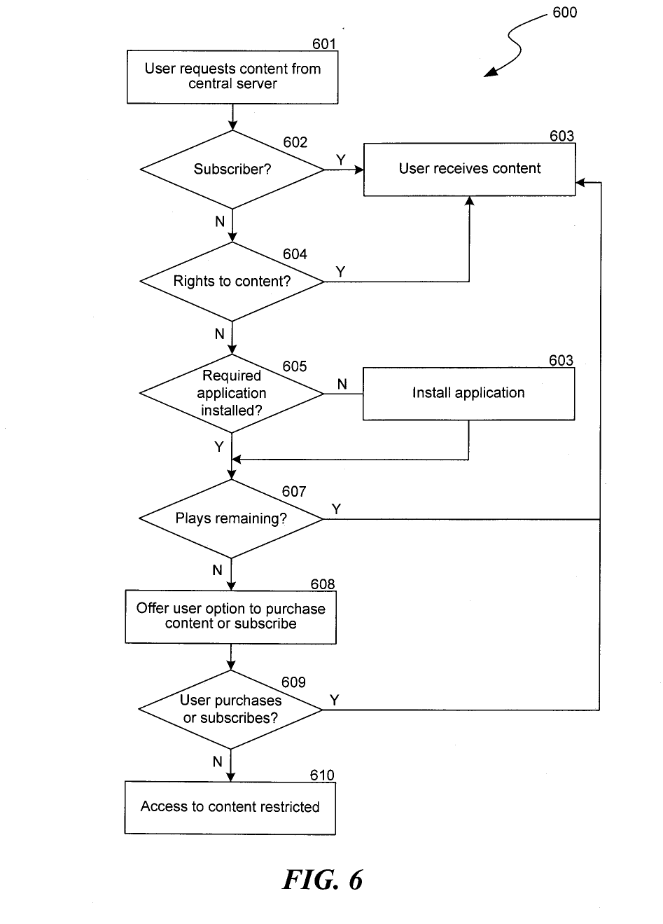

FIG. 6 illustrates a process 600 by which a user may receive content, or links to content, from the system when a limited number of plays are offered for free and the user is required to have an application installed prior to accessing content for free. At a block 601 the user requests content from the system. At a decision block 602 the system determines whether the user is a subscriber to a service offered by the system. If the user is a subscriber, at a block 603 the system provides the user with access to the content. If the user is not a subscriber, at a decision block 604 the system determines whether the user has rights to the content. For example, the user may have acquired rights to a song by purchasing the song. If the user has rights to the content, at a block 603 the system provides the user with access to the content. If the user does not have rights to the content, at a decision block 605 the system determines whether the user has a required application installed. If the user does not have the required application installed, at a block 606 the system provides the user with an option to install the application. The user may be required to accept a license agreement in order to install the application. If the user does not accept the license agreement or the application is not successfully installed, the system may restrict the functionality available to the user, as described above. If the user has installed the required application, at a decision block 607 the system determines whether the user has free plays remaining for the content file requested. This may be done, in part, using the system DRM rules described above. If the user has free plays remaining, at a block 603 the system provides the user with access to the content and may, for example, decrement the number of free plays remaining for that content file. If the user does not have free plays remaining, at a block 608 the system may offer the user the option to purchase the content file or subscribe to a service offered by the system. At a decision block 609 the system determines whether the user has decided to purchase the content file or subscribe to a service. If the user chooses to purchase the content file or subscribe to a service, at a block 603 the system provides the user with access to the content. If the user chooses not to purchase the content file or subscribe to a service, at a block 610 the system may restrict access to the content, as described above.

Various alternatives or additions to the system described above are possible. For example, the system may offer free content to users at a reduced bit rate or lower fidelity (e.g., 48 Kbps). The system may offer content to users at a higher bit rate (e.g., 128 Kbps) if a user purchases a content file or subscribes to a service offered by the system.

Alternatively or additionally, the system may only allow users who have purchased content files or subscribed to a service offered by the system to download content files. Those users accessing files for free may be permitted to stream or otherwise access the files, but may not be permitted to download the files.

Alternatively or additionally, the system may restrict the kind of device on which content files may be played. For example, a user who acquires content files for free may only be permitted to play those files on the user's computer system. A user who has purchased content files or subscribed to a service offered by the system may be permitted to play content files on the user's computer system, transfer the files to one or more mobile devices for play, burn the files to a CD, and use the files on other devices.

The system may offer subsets of services to users at different price levels. For example, the system may provide users with limited access to content files, e.g., users may only access files on their computer systems, for a certain fee. For a higher fee, the system may allow users to transfer the files to a mobile device, burn the files to a CD, or use the files in other ways.

Alternatively or additionally, users may be able to create personal profile pages. These profile pages may be hosted by a network site provided by the system. Users may post playlists, personal content libraries, personal information, and other information on their profile pages. Users may be able to search and view the profile pages of other users. In some examples, users may be required to register with the system, have a client-side application installed, or, if the user is already registered, log in to a network site to access the user's own profile page and/or to search or view the profile pages of other users.

Alternatively or additionally, users may be able to save content files to a personal content library. If a user has purchased one or more content files or subscribed to a service offered by the system, the system may permit the user to save one or more content files to the user's personal content library. As long as the user retains rights to the content files or continues to subscribe to a service, the user will be able to access content files from the user's library. If a user has not purchased one or more content files and is not a subscriber (i.e., the user is accessing content files for free), the system may permit the user to save one or more content files to the user's library if the user has a required application installed on the user's computer system. As long as the user keeps the application installed and has free plays of the content files remaining, the user will be able to access content files from the user's library. If a user uninstalls a required application, the user may still be able to view the user's library, but may not be able to access the files (e.g., play music) in the library. The system may display information to the user about the files in the user's library, including artist, title, and other information. In some examples, a user's library may be displayed on the user's profile page. Users may search the libraries of other users. For example, a user may want to know what is in his friends' libraries, or a user may want to search the libraries of other users who have similar content files in their libraries.

Users may create, share, and download one or more content playlists. A playlist is a list of content files created by a user, a content provider, or by the system. Playlists may group content by characteristic, genre, or other feature, or they may be a random grouping, user-selected, content provider-selected, or system-selected grouping of content files. Users may be permitted to create playlists if they subscribe to a service offered by the system. Users may also be permitted to create playlists of content files they have rights to, e.g., have purchased. Users may also be permitted to create playlists if they have a required application installed on their computer systems, as noted above. One skilled in the art will appreciate that playlists may be created in other ways.

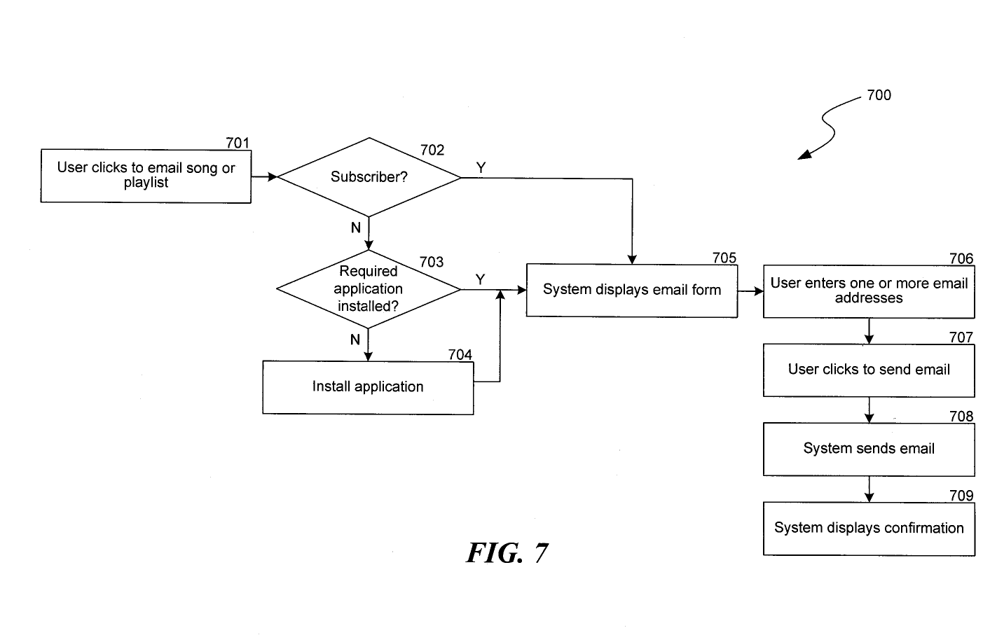

In some examples, users may share one or more playlists with other users via email, instant message, animated (e.g., flash) greeting card, or other method. In some examples, users may share playlists if they subscribe to a service offered by the system or if they have a required application installed on their computer systems. FIG. 7 illustrates a process 700 by which a user may email a playlist or a song to another user. At a block 701 the user clicks on an option (e.g., button or link on a network site provided by the system) to email a song or playlist to another user, or otherwise indicates a desire to email a song or playlist to another user. At a decision block 702 the system determines whether the user is a subscriber. If the user is a subscriber, at a block 705 the system may display an email form to the user. The form may be pre-populated with a message, which may be edited by the user. If the user is not a subscriber, at a decision block 703 the system determines whether the user has a required application installed. If the user has the required application installed, at a block 705 the system may display an email form to the user. If the user does not have the required application installed, at a block 704 the system may provide the user with the option to install the application. As described above, the user may be required to accept a license agreement in order to install the application. If the user does not accept the license agreement or the application is not successfully installed, the system may restrict the functionality available to the user. If the user successfully installs the application, at a block 705 the system may display an email form to the user.

Once the system has displayed the email form to the user at a block 705, at a block 706 the user may enter one or more email addresses of recipients to whom the user's playlist or song will be sent. At a block 707 the user clicks a button or link to send the email, or otherwise indicates that the form is complete and the user wishes to send the email. At a block 708 the system sends an email to the email addresses entered by the user. The email may contain the playlist, a link to the playlist, and/or other information entered by the user or the system. At a block 709 the system displays confirmation to the user that the email was successfully sent.

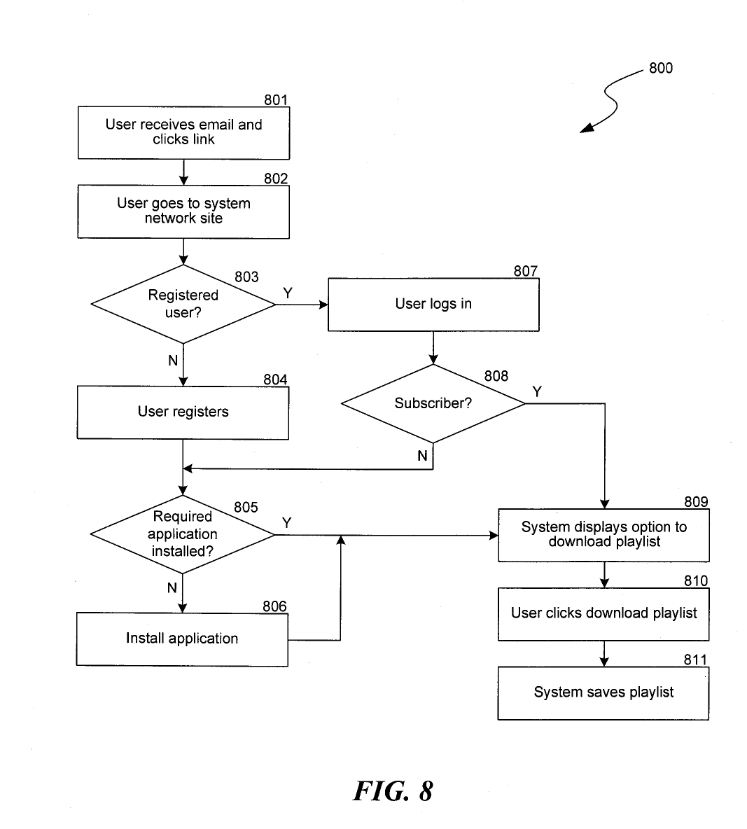

Users may download one or more songs or playlists via an email message, an instant message, a network site provided by the system, an animated (e.g., flash) greeting card, another user's profile, or in another manner. In some examples, a user may receive an email with a link to a song or playlist. FIG. 8 illustrates a process 800 by which a user may access a song or playlist sent to the user as a link in an email. At a block 801 the user receives an email and clicks on the link associated with the song or playlist. At a block 802 the user is taken to a network site offered by the system. The user may be required to register with or, if already registered, log in to the network site.

At a block 803 the system determines whether the user is a registered user. If the user is registered, at a block 807 the user logs in to the system. The user may be permitted to download the song or playlist if the user is a subscriber to a service offered by the system. At a decision block 808 the system determines whether the logged-in user is a subscriber. If at block 803 the system determined that the user was not a registered user, at a block 804 the system may present the user with the option of registering. The user may be permitted to download the song or playlist, free of charge, if the user has a required application installed on the user's computer system. If the system newly registers the user at block 804 or determines at block 808 that a logged-in user is not a subscriber, at a decision block 805 the system determines whether the user has a required application installed. If the user does not have the required application installed, at a block 806 the system may offer the user an opportunity to install the required application. If the user has installed the application, or the user was determined to be a subscriber at block 808, at a block 809 the system may display to the user an option (e.g., link or button) to download the song or playlist. At a block 810 the user may click to download the song or playlist, and at a block 811 the system saves the song or playlist.

Again, many alternatives or additions are possible. For example, a user may download one or more songs or playlists from another user's profile. Each user may display one or more songs or playlists on a profile page. Users may be required to register with or, if already registered, log in to the network site in order to view other users profile pages, including other users' songs and playlists. A user may click on another's user's song or playlist to download the song or playlist. A user may be permitted to download the song or playlist if the user is a subscriber to a service offered by the system. The user may also be permitted to download the song or playlist, free of charge, if the user has a required application installed on the user's computer system.

Alternatively or additionally, users may invite others to join a service offered by the system. Users may invite others to join a service by sending individual content files, playlists, or both, to others via email, instant message, animated (e.g., flash) greeting card, or other method.

Alternatively or additionally, the system may offer free products or services for mobile devices (e.g., ring tones, song downloads) in exchange for a user installing a required application on the user's computer system, mobile device, or other compatible system. Advertisements may be displayed to the user via the application, such as in a time-shifted manner described below.

Returning to FIG. 4, at a block 407 the system provides advertisements to the user. In some examples, the system may present advertisements to users via an application that is installed on a user's computer system. In some examples, the advertisements may be time-shifted. That is, an advertisement may not be provided along with the content; instead, the advertisement may be presented separately from the content. For example, when a user enters a URL into a browser or conducts a search, such as by entering one or more search terms at a network search site or into an application installed on the user's computer system, an advertisement may be presented to the user based on the search terms, keywords, or URL entered by the user, or based on another targeting criteria. The system may display to the user the advertisement with the highest bid value for the keyword. For example, if advertiser X has bid $0.05 for keyword 1 and advertiser Y has bid $0.03 for keyword 1, the system will display advertiser X's advertisement. At a block 408 the system receives compensation from advertisers. An advertiser may pay compensation in the amount the advertiser has bid for the keyword associated with an advertisement when the advertisement is displayed to a user. For example, when advertiser X's advertisement is displayed by the system in response to a user entering keyword 1 in a search query, it may pay $0.05.

At a block 409 the system provides compensation to content providers. The compensation provided to each content provider may vary based on how many users access a service provided by the system during a particular time period or based on other usage data, such as how many times a given content file is accessed. In some examples, each content provider may receive a share of the advertising revenue that is generated by each user that accesses content during a particular time period. In some examples, a content provider may receive a different share of the advertising revenue based on whether it is the content provider's content that enticed the user to use a service offered by the system. For example, if a user installs a required application in order to listen to a song provided by a first content provider, the first content provider may receive a 40% share of the advertising revenue generated by the user. A user of this type, who has not previously installed a required application, may be referred to as an organic or primary user. If a user already has the required application installed and chooses to listen to a song provided by a second content provider, the second content provider may receive a 30% share of the advertising revenue generated by the user. A user of this type, who has previously installed a required application, may be referred to as a non-organic, tertiary, or internal user. In some examples, the amount of revenue received by a content provider may be based on more than one time period. For example, a content provider may be paid based on whether a user accesses content during a given month, but the content provider may receive payment only for those weeks in which the user accesses content. For instance, a content provider may qualify for payment because a user accessed content in month 1. However, the content provider may only receive its share (e.g., 30% or 40%) of advertising revenue for week 1 of month 1 if the user only accessed content during week 1. This may be referred to as breakage. In some examples, content providers may be guaranteed a minimum amount of compensation for each user who uses a service provided by the system during a particular time period. For example, a content provider might be guaranteed $0.06 per user per week or $0.25 per user per month, for all users that access a service.

The system may track statistics and offer one or more reports containing those statistics to advertisers and content providers. For example, the system may track, for each advertisement, the number of times the advertisement was displayed, the keyword that triggered display of the advertisement, the amount paid by the advertiser for display, and other statistics. These statistics may be reported to advertisers. As another example, the system may track, for each content provider, the content files accessed by each user; content files saved to each user's personal content library; content files or playlists created, sent, or downloaded by each user; and other statistics. These statistics may be reported to content providers. The system may also track and report other information, including number of registered users, purchase of content files, number of subscribers, and other information.

In general, the detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the invention reside on a server computer, while corresponding portions reside on a client computer such as a mobile or portable device, and thus, while certain hardware platforms are described herein, aspects of the invention are equally applicable to nodes on a network.

The teachings of the invention provided herein can be applied to other systems, not necessarily the system described herein. The elements and acts of the various examples described herein can be combined to provide further examples.

Any patents, applications, and other references, including any that may be listed in accompanying filing papers, are incorporated herein by reference. Aspects of the invention can be modified, if necessary, to employ the systems, functions, and concepts of the various references described above to provide yet further examples of the invention.

These and other changes can be made to the invention in light of the above Detailed Description. While the above description details certain examples of the invention and describes the best mode contemplated, no matter how detailed the above appears in text, the invention can be practiced in many ways. Details of the invention may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention.

I/We claim:

1. A system for providing digital content and advertisements to users via a public computer network, the system comprising:
a coordinating server, wherein the coordinating server is coupled among at least one remote advertiser server, at least one remote content server, and multiple user computers, via the computer network, and wherein the coordinating server is configured to:
receive digital advertisements from the at least one remote advertiser server which is associated with multiple advertisers, wherein the advertisers provide compensation based on presenting the digital advertisements to the users;
receive digital content, or access to digital content, from the at least one remote content server which is associated with at least one content provider, wherein the content provider receives a variable amount of compensation based on how many of the users access the digital content during a particular time period, and wherein the digital content includes digital music files;
provide free to the users the digital content and the digital advertisements, wherein the users may select desired digital music files, wherein the digital advertisements are presented to the users after they have listened to the digital content, and wherein the digital advertisements are related to digital content or context of individual users;
track users' access to the digital content during the particular time period; and,
provide a portion of the advertiser compensation to the content providers based at least in part on the tracked access to the digital content during the particular time period.

2. The system of claim 1 wherein the compensation received by each content provider is a share of the advertising revenue generated by each user who accesses digital content during a particular time period, and wherein the user computers include mobile devices.

3. The system of claim 1 wherein each of the advertisers specifies one or more keywords associated with each of its advertisements.

4. The system of claim 3 wherein each of the advertisers specifies a bid value for each of the one or more keywords, and wherein the bid value is an amount of compensation the advertiser is willing to provide for the presentation of its advertisement to a user.

5. The system of claim 1 wherein neither digital content nor digital advertisements are provided to users unless the users have a client-side, advertisement-providing application installed.

6. The system of claim 1 wherein the digital advertisements are time-shifted, wherein the time-shifting constitutes providing at least one of the digital advertisements to one or more of the users when the users conduct a search using one of multiple selected keywords associated with the at least one advertisement.

7. The system of claim 1 wherein each of the content providers are paid at least a flat rate for each of the users that accesses the digital content during a particular time period.

8. The system of claim 1 wherein each digital content file may only be played by a user a limited number of times.

9. The system of claim 8 wherein, for each digital content file, upon expiration of the limited number of times the file may be played, the user is presented with the opportunity to purchase the file or subscribe to a service offered by the system.

10. The system of claim 1 wherein digital advertisements include at least one page from at least one advertiser's website to be displayed to users.

11. A method for providing digital music to users, the method comprising:
receiving digital advertisements from advertisers, wherein the advertisers provide compensation based on presenting the digital advertisements to the users;
receiving digital music from content providers, wherein content providers receive a variable amount of compensation based on how many of the users access the digital music during a particular time period; and
providing the digital music and the digital advertisements to the users, wherein the digital advertisements are context-sensitive and are provided after at least a portion of the digital music is provided to the users.

12. The method of claim 11 wherein the compensation received by each content provider is a share of the advertising revenue generated by each user who accesses digital music during a particular time period, and wherein the share of the advertising revenue is calculated based on whether each user has previously installed a client-side, advertisement-providing application.

13. The method of claim 11 wherein each of the advertisers specifies one or more keywords associated with each of its advertisements.

14. The method of claim 13 wherein each of the advertisers specifies a bid value for each of the one or more keywords, wherein the bid value is an amount of compensation the advertiser is willing to provide for the presentation of its advertisement to a user.

15. The method of claim 11 wherein neither digital music nor digital advertisements will be provided to users unless the users have a client-side application installed.

16. The method of claim 13 wherein the digital advertisements are time-shifted, wherein the time shifting constitutes providing at least one of the digital advertisements to one or more of the users when the users conduct a search using one of the keywords associated with the at least one advertisement.

17. The method of claim 11 wherein each of the content providers are paid at least a flat rate for each of the users that accesses the digital music during a particular time period.

18. The method of claim 11 further comprising providing premium services to users based on payment by the users, the premium services including at least one of downloading digital music to a computer, transferring digital music to a mobile device, or burning digital music onto a CD.

19. The method of claim 11 wherein, for each digital music file, upon expiration of a limited number of times the file may be played, the user is presented with the opportunity to purchase the file or subscribe to a service offered by the system.

20. A system for users to select to receive or access user-specified digital audio files, the system comprising:
means for receiving digital advertisements from advertisers, wherein the advertisers provide compensation based on presenting the digital advertisements to the users;
means for receiving digital audio files from content providers, wherein content providers receive compensation based on users access to the digital audio files; and
means for providing the digital audio files and the digital advertisements to the users, wherein the digital advertisements are context-sensitive and are provided after at least a portion of the digital audio files are provided to the users.

21. The system of claim 20 wherein at least some users may search the digital audio files that at least one other user has received, accessed, or maintains in a library.

22. The system of claim 20 wherein at least some users may search for a profile maintained by at least one other user, wherein a profile is a network site page maintained by the user, wherein a search may be conducted by entering at least one of a user's name, an identifier associated with the user, or one or more files received, accessed, or maintained in a library by the user.

23. The system of claim 22 wherein each profile may contain at least one playlist, wherein a playlist is a list of one or more audio files, and wherein the playlist is created by a user, a content provider, or the system.

24. The system of claim 20 wherein each user may send one or more audio files, or links to one or more audio files, to at least one other user via email, or instant message.

25. The system of claim 24 wherein the one or more audio files, or links to one or more audio files, are sent via a flash animated greeting card.

26. A computer-readable medium encoded with processing instructions for implementing a method, performed by a computer, for providing a digital music service to users, the method comprising:
receiving digital advertisements from advertisers, wherein the advertisers provide compensation based on presenting the digital advertisements to the users;
receiving digital music from content providers, wherein content providers receive a variable amount of compensation based on users access to the digital music service during a particular time period; and
providing the digital music and the digital advertisements to the users, wherein the digital advertisements are time-shifted with respect to least a portion of the digital music provided to the users.

27. The computer-readable medium of claim 26 wherein the digital advertisements include directing users to at least one advertiser's website.

28. The computer-readable medium of claim 27 wherein each of the advertisers specifies at least one keyword associated with each of its advertisements, wherein at least one digital advertisement is presented to at least one user when the user conducts a search using one of the at least one keywords associated with the advertisement.

29. The computer-readable medium of claim 26 further comprising providing premium services to users based on payment by the users, the premium services including at least one of downloading digital music to a computer, transferring digital music to a mobile device, or burning digital music onto a CD.
